(19) United States
(12) Patent Application Publication
(10) Pub. No.: US 2005/0142277 A1
(43) Pub. Date: Jun. 30, 2005

(54) Method of producing a soya bean product

(75) Inventor: Errol Murray Collins, Cape Town (ZA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Specialised Protein Products (Proprietary) Limited, Industria (ZA)

(21) Appl. No.: 10/748,879

(22) Filed: Dec. 29, 2003

(51) Int. Cl. A23L 1/20

(52) U.S. Cl. 426/634

(57) ABSTRACT

A method of producing a soya bean product includes the step of exposing soya beans to an acidic aqueous solution at a pH of between about 2.0 and 5.5. The soya beans are whole beans and the organic acid is citric acid. The soya bean product is soya milk.

THIS INVENTION relates to a method of producing a soya bean product and to a soya bean product produced in accordance with the method.

Soya beans, also called soybeans, are widely used as a source of protein. The main products derived from soya beans are soya milk, soya oil, soya protein and soya bean meal.

According to a first aspect of the invention, there is provided a method of producing a soya bean product, the method including the step of exposing soya beans to an aqueous solution having a pH of between about 2.0 and 5.5.

The soya beans may be whole beans i.e. soya beans which have not been de-hulled.

The method may include the prior step of dissolving an organic acid in water to produce the aqueous solution having a pH of between about 2.0 and 5.5.

The organic acid may be citric acid or ascorbic acid.

A pH of between about 2.0 and 5.5 inhibits the lipoxygenase reaction which generally causes off flavours and off colours in soya products such as soya milk. In prior art processes, soya beans have generally been processed by a wet method which involves de-hulling of the beans. Because the lipoxygenase enzyme is concentrated in the hull of the bean, it is believed that, when de-hulling and wet processing takes place, the biological activity of the enzyme is increased when it comes into contact with oxygen and water when the hull is ruptured. The enzyme then oxidizes lipids in the bean. This is believed to lead to the formation of “grassy”, “beany” or “paint-like” off flavours and off odours in the soya product and particularly in the soya milk which is produced. The method of the invention requires no prior de-hulling of the beans and substantially reduces the problem of off flavours and off odours to the extent that they present little or no problem.

The method may include the prior step of dissolving both an organic acid and a sugar in the water to produce the aqueous solution having a pH of between about 2.0 and 5.5. The method may thus include the step of dissolving a sugar in the water.

The method may, instead, include the prior step of combining the organic acid and the sugar to form an additive and dissolving the additive in water to produce the aqueous solution. The sugar may be selected from dextrose, glucose and sucrose. In particular, the sugar may be dextrose.

The soya beans may be exposed to the acidic aqueous solution by soaking the beans in the acidic aqueous solution for a period of between about 4 and 12 hours. The soya beans may be exposed to the acidic aqueous solution by soaking the beans in the acidic aqueous solution at a temperature of between about 2 and 16° C.

The mass ratio of the organic acid to the sugar in the acidic aqueous solution may be between about 100:0 and 1:1. Preferably, the mass ratio will be about 1:1. The mass ratio of the combined organic acid and sugar to the soya beans may be between about 0.1:100 and 2:100.

The method may include the further step of separating the soya beans from the aqueous solution and then blanching the soaked beans. The blanching step may be conducted at a temperature of between about 95 and 100° C. It may be conducted for a period of between about 2 and 6 minutes. Separating the soaked soya beans may be by draining and rinsing the soaked beans.

The method may include the subsequent step of milling the blanched soya beans to produce a slurry comprising a soya milk fraction and a soya solids fraction and separating the soya milk fraction from the soya solids fraction. The milling step may be a wet milling step and may be conducted at a temperature of between about 65 and 98° C. Preferably, the successive steps of soaking, separating, blanching and milling are conducted without any substantial delays between the steps. The time interval between each of the successive steps of soaking, separating, blanching and milling will preferably be as short as possible and is preferably between about 15 and 30 minutes.

The method may include spray-drying the soya milk to produce a spray-dried powder.

According to a second aspect of the invention, there is provided a method of producing a soya bean product by processing soya beans, the method including the step of at least partially decreasing the biological activity of oxidizing enzymes in the soya beans.

The soya beans may have hulls and the oxidising enzymes may largely be contained in the hulls. The enzymes may be lipoxygenase enzymes or trypsin inhibitors.

The biological activity of the oxidizing enzymes may be at least partially decreased by exposing the soya beans to an acidic aqueous solution.

The acidic aqueous solution may have a pH of between about 2.0 and 5.5 The method may include the prior step of dissolving an organic acid in water to produce the aqueous acidic solution.

The organic acid may be citric acid or ascorbic acid.

The method may include the prior step of dissolving a sugar in the water.

Instead, the method may include the prior step of combining the organic acid and the sugar to form an additive and dissolving the additive in the water.

The sugar may be selected from dextrose, glucose and sucrose.

The soya beans may be exposed to the acidic aqueous solution by soaking the beans in the acidic aqueous solution for a period of between about 4 and 12 hours. The soya beans may be exposed to the acidic aqueous solution by soaking the beans in the acidic aqueous solution at a temperature of between about 2 and 16° C.

The mass ratio of the organic acid to the sugar in the acidic aqueous solution may be between about 100:0 and 1:1. Preferably, the mass ratio is about 1:1.

The mass ratio of the combined organic acid and sugar to the soya beans may be between about 0.1:100 and 2:100.

The method may include the further step of separating the soya beans from the aqueous solution and then blanching the separated beans.

The blanching step may be conducted at a temperature of between about 95 and 100° C. The blanching step may be conducted for a period of between about 2 and 6 minutes.

The method may include the step of milling the blanched soya beans to produce a slurry comprising a soya milk fraction and a soya solids fraction and separating the soya milk fraction from the soya solids fraction.

The milling step may be a wet milling step. The wet milling step may be conducted at a temperature of between about 65 and 98° C.

The time interval between each of the successive steps of soaking, separating, blanching and milling will be as short as possible and is preferably between about 15 and 30 minutes.

The method may include spray-drying the soya milk to produce a spray-dried powder.

According to a third aspect of the invention there is provided a soya bean product produced in accordance with a method as hereinbefore described.

The soya bean product may be soya milk.

The invention extends to an additive comprising an organic acid and a sugar for use in a method as hereinbefore described.

The invention is now described, by way of example, with reference to the accompanying diagrammatic drawings and Tables, in which

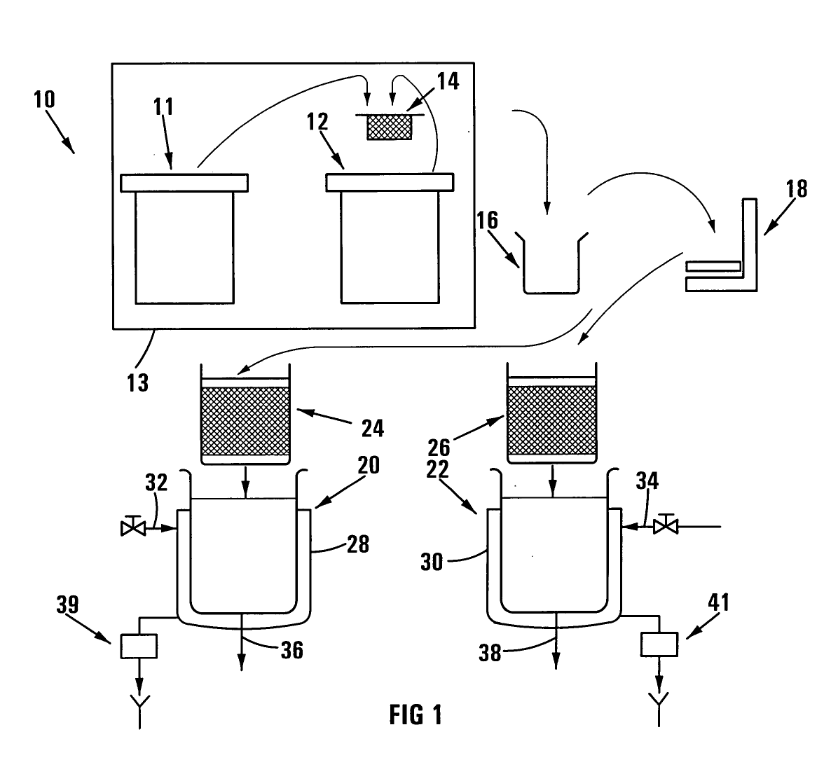

FIG. 1 is a schematic diagram of a first part of a soya bean processing plant;

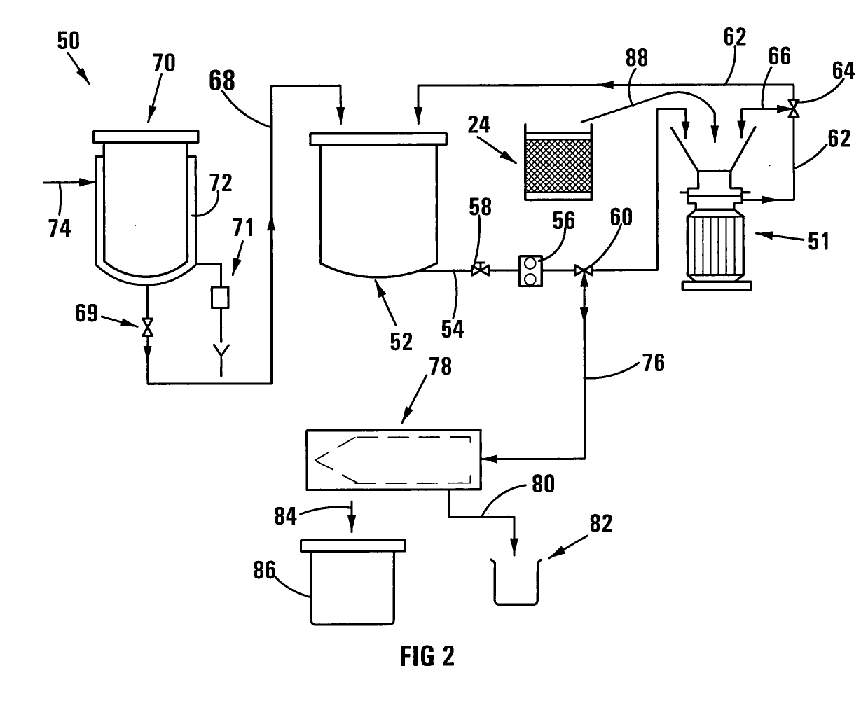

FIG. 2 is a schematic diagram of a second part of the soya bean processing plant of FIG. 1; and

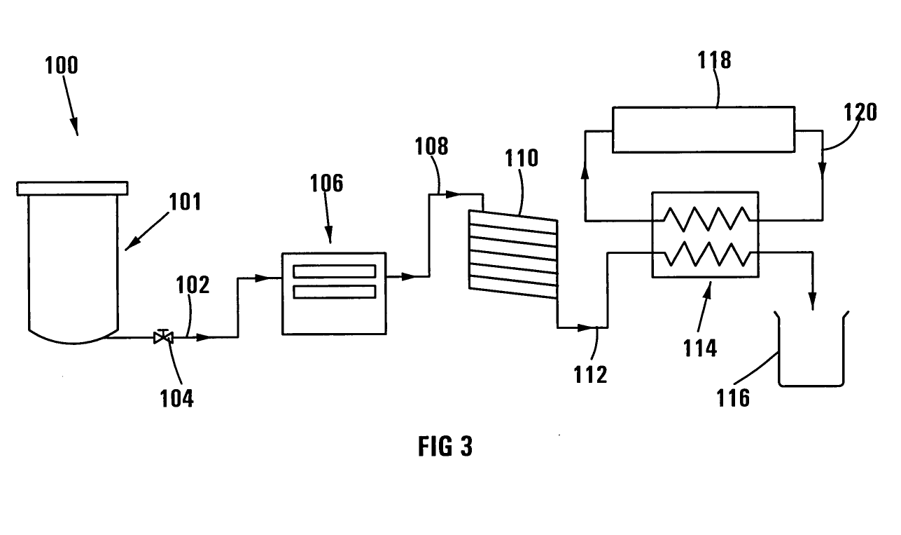

FIG. 3 is a schematic diagram of a third part of the soya bean processing plant of FIG. 1.

Referring to FIG. 1, reference numeral 10 generally indicates, schematically, a first part of a soya bean processing plant for the production of soya milk in accordance with the method of the invention.

The part 10 of the processing plant includes two 200 litre plastics soaking tanks 11, 12 in which soya beans are soaked in baskets of which one is shown schematically at 14. The soaking tanks 11, 12 are kept in a cold room represented schematically by the rectangle 13 which maintains the tanks at a temperature of about 8° C. The part 10 further includes a container 16 in which the drained beans are held prior to being weighed on a scale 18. The part 10 further includes two blanching vessels 20, 22 and two blanching baskets 24, 26 in which, in use, the soya beans are blanched. Each of the blanching vessels 20, 22 has a capacity of about 120 litres and each is provided with a heating jacket 28, 30 heated respectively by a steam-inlet conduit 32, 34 respectively. The blanching vessels 22, 24 are provided with drainage outlets schematically represented by the arrows 36, 38 and with expansion boxes and steam traps indicated by reference numerals 39, 41.

Referring to FIG. 2, the second part of the processing plant, generally indicated by reference numeral 50, includes a colloid mill 51 which is fed from a 200 litre holding tank 52 via a conduit 54 which includes a slurry pump 56, a valve 58 downstream of the holding tank 52 and upstream of the slurry pump 56 and a three-way valve 60 downstream of the slurry pump 56 and upstream of the colloid mill 51. A recycle flow line 62 extends from the colloid mill back to the holding tank 52 and includes a three-way valve 64 from where a feedline 66 extends back to the colloid mill. The holding tank 52 is fed with warm water via a feedline 68 from a warm water vessel 70 which is provided with a steam jacket 72 heated by a steam inlet schematically indicated by the arrow 74 and an expansion box and steam trap generally indicated by reference numeral 71. The feedline 68 includes a valve 69. A slurry feedline 76 extends from the three-way valve 60 to a decanter 78 from where a feedline 80 extends to a soya milk reservoir 82. Solid material in the form of wet meal or okara is collected, as is shown schematically by the arrow 84, in a holding tank 86. In the Figure the blanched beans are shown being added to the colloid mill 51, as indicated schematically by the arrow 88, from one of the blanching baskets 24.

Referring now to FIG. 3, the third part of the soya bean processing plant, generally indicated by reference numeral 100, includes a blending tank 101 which is connected via a feedline 102, which includes a valve 104, to a homogeniser 106. A feedline 108 connects the homogeniser 106 to an ultra high temperature (UHT) pasteurising unit 110 from which a flowline 112 extends via a cooler 114 to a soya milk storage vessel 116. The refrigerating unit which cools the cooler 114 is shown schematically by the rectangle 118 and flowlines 120.

In separate runs using 40 kg each of a USA grade yellow 2 soya bean, about 140 litres of soaking water comprising an aqueous solution of citric acid (1.4 kg) and dextrose (1.4 kg) was cooled to 8° C. in the soaking tanks 11, 12 and the soya beans were added to the tanks 11, 12 and left to soak overnight. The batches of beans were then withdrawn from the soaking tanks 11, 12, drained and weighed on the scale 18. The respective batches of beans were then transferred to the blanching baskets 24, 26 which were submerged in the blanching pots 20, 22. Each blanching pot 20, 22 contained about 120 litres of water at a temperature of about 98° C. The beans were blanched for 5 minutes and were then transferred to the colloid mill 51 where the blanched beans were milled. The blanching pots 20, 22 were half drained via the drainage outlets 36, 38 and topped up with water. The water in the blanching vessels contained lime at a pH of 9.

Warm water at a temperature of 85° C. was transferred in 120 litre batches from the warm water vessel 70 via the feedline 68 to the holding tank 52. Circulation of water through the colloid mill 51 via the flowlines 54, 62 and back to the holding tank 52 was started before the batches of beans were added to the colloid mill 51. The blanched beans were slowly introduced via a hopper located above the colloid mill 51. The slurry formed in the colloid mill 51 was transferred via the line 62 back to the holding tank 52. Once all of the beans had been added to the mill 51, the setting of the mill 51 was adjusted to produce a smaller particle size and the milling process was continued for 15 minutes.

The slurry was then fed via the valve 60 and the flowline 76 to the decanter 78 and the desludged soya filtrate was collected in the reservoir 82. It was then weighed and transferred to a holding tank (not shown). The wet meal (okara) was collected in the holding tank 86 and weighed. The raw soya milk which collected in the reservoir 82 was transferred to the blending tank 101 and weighed amounts of salt (50 g/200 l) and sugar (50 g/200 l) were blended into the milk in the blending tank 101. The resulting blend was then pumped from the blending tank 101 at a rate of 60 litres per hour via the feedline 102 to the homogeniser 106. The homogeniser 106 was maintained at a pressure of 200 kg/cm² gauge. From the homogeniser 106 the milk was pumped via the feedline 108 to the UHT pasteurising unit 110 where it was heated to a temperature of 140° C. for 3 seconds. The heated milk was then passed through the feedline 112 to the cooler 114 where it was cooled to a temperature of 10° C. The cooled milk was then allowed to flow into the soya milk storage vessel 116.

The results of 5 further batches of USA Yellow No. 2 beans processed in accordance with the method described above are set out in Table 1.

TABLE 1

| DESCRIPTION | BATCH 1 | BATCH 2 | BATCH 3 | BATCH 4 | BATCH 5 |
|---|---|---|---|---|---|
| BLANCHING: | | | | | |
| RINSED SOAKED BEANS (KG) | 39.5 | 40.5 | 39.8 | 40.6 | 40.5 |
| CALCULATED DRY BEANS (KG) | 19.75 | 20.25 | 19.9 | 20.3 | 20.25 |
| WATER pH BEFORE BLANCHING | 10.3 | 10.5 | 10.1 | 9.5 | 10.2 |
| BLANCH TIME (MINUTES) | 5 | 5 | 5 | 5 | 5 |
| WATER pH AFTER BLANCHING | 7.1 | 7.2 | 7 | 6.9 | 7.1 |
| EXTRACTION: | | | | | |
| EXTRACTION WATER LOADED (L) | 108 | 125 | 120 | 120 | 120 |
| EXTRACTION WATER TEMP (° C.) | 83 | 85 | 78 | 89 | 81 |
| MILLING ROUGH SETTING (MIN) | 10 | 10 | 10 | 10 | 10 |
| MILLING FINE SETTING (MIN) | 12 | 15 | 13 | 15 | 15 |
| DECANTER: | | | | | |
| FEED RATE (L/H) | 240 | 260 | 240 | 240 | 240 |
| MILK YIELDED (L) | 97 | 118.6 | 109 | 118.5 | FAILURE |
| ACCUM. OKARA WEIGHED (KG) | 36 | 68 | 103 | 135 | |
| DEAD VOLUMES & RETAINED | 14.5 | 14.9 | 15.8 | 10.1 | |
| MASS IN DECANTER (KG) | | | | | |
| BLENDING: | | | | | |
| SUGAR ADDED (GRAMS) | 1,500 | 2,500 | 2,720 | 2,900 | |
| SALT ADDED (GRAMS) | 50 | 215 | 220 | 230 | |
| HOMOGENISATION: | | | | | |
| PRESSURE (kg/cm³) | 200 | 200 | 200 | 200 | |
| FLOW RATE (L/HR) | 160 | 160 | 160 | 160 | |
| UHT TREATMENT: | | | | | |
| TEMPERATURE (° C.) | 140 | 140 | 140 | 140 | |
| HOLDING TIME (SEC) | 3 | 3 | 3 | 3 | |
| OUTLET TEMP (° C.) | 10 | 14 | 16 | 22 | |

Results of Sample Analysis

A summary of the analyses of four batches of soya milk and okara from five batches is shown in Table 2. The adjusted values representing the sample prior to the addition of sugar are shown in Table 3.

TABLE 2
Summary of Analysis

| Sample | | Total | | | Dietary | | | Energy |
|---|---|---|---|---|---|---|---|---|
| No. | Description | Protein | Fat/Oil | Carbohydrates | Fibre | Ash | Moisture | (Kj/100 g) |
| 227 | Okara, | 10.23% | 5.59% | 0.40% | 7.07% | 0.84% | 75.87% | 387 |
| | Batch 1 & 2 | | | | | | | |
| 228 | Milk Batch 2, | 2.43% | 1.78% | 3.57% | 0.30% | 0.46% | 91.46% | 164 |
| | After | | | | | | | |
| | UHT | | | | | | | |
| 229 | Milk Batch 2, | 2.55% | 1.83% | 3.46% | 0.70% | 0.38% | 91.08% | 166 |
| | Before UHT | | | | | | | |
| 230 | Milk Batch 4, | 2.47% | 1.04% | 4.15% | 0.31% | 0.35% | 91.68% | 147 |
| | After UHT | | | | | | | |

TABLE 3
Values with and without Sugar

| | BATCH 2 | | BATCH 4 | |
|---|---|---|---|---|
| | SAMPLE NO. 229 | | SAMPLE NO. 230 | |
| | WITH | | WITH | |
| ITEM | SUGAR | WITHOUT | SUGAR | WITHOUT |
| SUGAR ADDED | 2.06% | | 2.39% | |
| Protein (%) | 2.55 | 2.60 | 2.47 | 2.53 |
| Fat/Oil (%) | 1.83 | 1.87 | 1.04 | 1.07 |
| Carbohydrates (%) | 3.46 | 1.43 | 4.15 | 1.80 |
| Dietary Fibre (%) | 0.70 | 0.71 | 0.31 | 0.32 |
| Ash (%) | 0.38 | 0.39 | 0.35 | 0.36 |
| Moisture (%) | 91.08 | 93.00 | 91.68 | 93.92 |
| | 100.00 | 100.00 | 100.00 | 100.00 |
| Solids Content (%) | 8.92 | 7.00 | 8.32 | 6.08 |

It is an advantage of the invention illustrated that the method of the invention produces a soya bean product, in particular a soya bean milk, which does not have the “grassy”, “beany” or “paint-like” taste which is associated with the product produced by the traditional Chinese method of water extraction. Generally, the relative abundance of animal protein and the off flavours of soya products have resulted in a lack of interest in soya products despite the excellent nutritional value of soya milk and related products. A great deal of research has, in the past, concentrated on solving the problem of enzyme activity. This research has, for example, resulted in processes which incorporate deodorisation steps downstream of the de-hulling step. With one exception, prior art processes of which the Applicant is aware, incorporate de-hulling in the production of soya milk. In addition to the production of off flavours and off odours, another problem associated with de-hulling is that the process is seldom achieved with 100% effectiveness. This generally results in the loss of about 10% of the mass of the bean with associated loss of protein and bland tasting fibre. The only whole bean process known to the Applicant, i.e. the only process known to the Applicant which does not involve de-hulling of the beans, is an expensive oxygen starvation process in which the processing of the bean takes place in a deoxygenated atmosphere. However, the process is expensive and requires specialised equipment and operating procedures to achieve an oxygen-free environment. It is a particular advantage of the invention illustrated that the soya milk production process of the invention does not require de-hulling of the bean. The pre-treatment process of the invention is simple and inexpensive when compared with prior art processes of which the Applicant is aware and the extraction process of the invention produces a product which does not have the off flavours or off odours associated with prior art products. The product is an excellent tasting, highly digestible soya milk.

1. A method of producing a soya bean product, the method including the step of exposing soya beans to an acidic aqueous solution.

2. A method as claimed in claim 1, in which the acidic aqueous solution has a pH of between about 2.0 and 5.5.

3. A method as claimed in claim 1, in which the soya beans are whole beans.

4. A method as claimed in claim 1, which includes the prior step of dissolving an organic acid in water to produce the aqueous acidic solution.

5. A method as claimed in claim 4, in which the organic acid is citric acid.

6. A method as claimed in claim 4, which includes the step of dissolving a sugar in the water.

7. A method as claimed in claim 6, which includes the prior step of combining the organic acid and the sugar to form an additive and dissolving the additive in the water.

8. A method as claimed in claim 6, in which the sugar is selected from dextrose, glucose and sucrose.

9. A method as claimed in claim 1, in which the soya beans are exposed to the acidic aqueous solution by soaking the beans in the acidic aqueous solution for a period of between about 4 and 12 hours.

10. A method as claimed in claim 1, in which the soya beans are exposed to the acidic aqueous solution by soaking the beans in the acidic aqueous solution at a temperature of between about 2 and 16° C.

11. A method as claimed in claim 6, in which the mass ratio of the organic acid to the sugar in the acidic aqueous solution is between about 100:0 and 1:1.

12. A method as claimed in claim 11, in which the mass ratio is about 1:1.

13. A method as claimed in claim 9, in which the mass ratio of the combined organic acid and sugar to the soya beans is between about 0.1:100 and 2:100.

14. A method as claimed in claim 9, which includes the further step of separating the soya beans from the aqueous solution and then blanching the separated beans.

15. A method as claimed in claim 14, in which the blanching step is conducted at a temperature of between about 95 and 100° C.

16. A method as claimed in claim 14, in which the blanching step is conducted for a period of between about 2 and 6 minutes.

17. A method as claimed in claim 14, which includes the step of milling the blanched soya beans to produce a slurry comprising a soya milk fraction and a soya solids fraction and separating the soya milk fraction from the soya solids fraction.

18. A method as claimed in claim 17, in which the milling step is a wet milling step.

19. A method as claimed in claim 18, in which the wet milling step is conducted at a temperature of between about 65 and 98° C.

20. A method as claimed in claim 17, in which the time interval between each of the successive steps of soaking, separating, blanching and milling is between about 15 and 30 minutes.

21. A method of producing a soya bean product by processing soya beans, the method including the step of at least partially decreasing the biological activity of oxidizing enzymes in the soya beans.

22. A method as claimed in claim 21, in which the soya beans have hulls and in which the oxidising enzymes are largely contained in the hulls.

23. A method as claimed in claim 21, in which the enzymes are lipoxygenase enzymes.

24. A method as claimed in claim 21, in which the biological activity of the oxidizing enzymes is at least partially decreased by exposing the soya beans to an acidic aqueous solution.

25. A method as claimed in claim 24, in which the acidic aqueous solution has a pH of between about 2.0 and 5.5.

26. A method as claimed in claim 24, which includes the prior step of dissolving an organic acid in water to produce the aqueous acidic solution.

27. A method as claimed in claim 26, in which the organic acid is citric acid.

28. A method as claimed in claim 26, which includes the step of dissolving a sugar in the water.

29. A method as claimed in claim 28, which includes the prior step of combining the organic acid and the sugar to form an additive and dissolving the additive in the water.

30. A method as claimed in claim 28, in which the sugar is selected from dextrose, glucose and sucrose.

31. A method as claimed in claim 24, in which the soya beans are exposed to the acidic aqueous solution by soaking the beans in the acidic aqueous solution for a period of between about 4 and 12 hours.

32. A method as claimed in claim 24, in which the soya beans are exposed to the acidic aqueous solution by soaking the beans in the acidic aqueous solution at a temperature of between about 2 and 16° C.

33. A method as claimed in claim 28, in which the mass ratio of the organic acid to the sugar in the acidic aqueous solution is between about 100:0 and 1:1.

34. A method as claimed in claim 33, in which the mass ratio is about 1:1.

35. A method as claimed in claim 28, in which the mass ratio of the combined organic acid and sugar to the soya beans is between about 0.1:100 and 2:100.

36. A method as claimed in claim 31, which includes the further step of separating the soya beans from the aqueous solution and then blanching the separated beans.

37. A method as claimed in claim 36, in which the blanching step is conducted at a temperature of between about 95 and 100° C.

38. A method as claimed in claim 36, in which the blanching step is conducted for a period of between about 2 and 6 minutes.

39. A method as claimed in claim 36, which includes the step of milling the blanched soya beans to produce a slurry comprising a soya milk fraction and a soya solids fraction and separating the soya milk fraction from the soya solids fraction.

40. A method as claimed in claim 39, in which the milling step is a wet milling step.

41. A method as claimed in claim 40, in which the wet milling step is conducted at a temperature of between about 65 and 98° C.

42. A method as claimed in claim 39, in which the time interval between each of the successive steps of soaking, separating, blanching and milling is between about 15 and 30 minutes.

43. A method as claimed in claim 17, which includes spray-drying the soya milk to produce a spray-dried powder.

44. A method as claimed in claim 39 which includes spray-drying the soya milk to produce a spray-dried powder.

45. A soya bean product produced in accordance with a method as claimed in claim 1.

46. A soya bean product produced in accordance with a method as claimed in claim 21.

47. An additive comprising an organic acid and a sugar for use in a method as claimed in claim 7.

48. An additive comprising an organic acid and a sugar for use in a method as claimed in claim 29.
